(19) United States
(12) Patent Application Publication
(10) Pub. No.: US 2011/0274840 A1
(43) Pub. Date: Nov. 10, 2011

(54) APPARATUS AND METHOD OF FABRICATING THIN FILM PATTERN

(76) Inventors: Dhang Kwon, Gyeonggi-do (KR); Tae-Joon Song, Gyeonggi-do (KR); Hang-Sup Cho, Gyeonggi-do (KR); Seong-Pil Cho, Gyeonggi-do (KR); Ho-Su Kim, Gyeonggi-do (KR); Doo-Hee Jang, Gyeonggi-do (KR)

(21) Appl. No.: 13/098,686

(22) Filed: May 2, 2011

(30) Foreign Application Priority Data
May 4, 2010 (KR) 10-2010-0041747

(51) Int. Cl. B05D 3/12; B05C 11/02

(52) U.S. Cl. 427/277; 118/100

(57) ABSTRACT

An apparatus and a method of fabricating a thin film pattern, capable of forming a demolding seed between an imprinting mold and a substrate in a demolding process of demolding an imprinting mold from a substrate, are disclosed. The method of fabricating a thin film pattern includes coating imprinting resin on the other region except an edge region of a substrate, forming a thin film pattern on the substrate by contacting an imprinting mold with the imprinting resin, and demolding the imprinting mold from the substrate.

### CROSS REFERENCE TO RELATED APPLICATION

This application claims the benefit of the Patent Korean Application No. 10-2010-0041747, filed on May 4, 2010, which is hereby incorporated by reference as if fully set forth herein.

### BACKGROUND OF THE DISCLOSURE

1. Field of the Disclosure

The present invention relates to a thin pattern fabricating apparatus capable of forming a demolding seed between the imprinting mold and the substrate when demolding an imprinting mold from a substrate in a separation process, and a thin pattern fabricating method.

2. Discussion of the Related Art

In recent, a variety of flat display devices capable of the weight and volume of a cathode ray tube (CRT), which are disadvantages thereof, have been introduced. Such a flat display device includes a liquid crystal display, a field emission display, a plasma display panel and an electro-luminescence (EL) display.

Such the flat display device may be configured of a plurality of thin films formed by a mask process including a deposition (coating) process, an exposure process, a development process and an etching process. However, the mask process has a problem of high fabrication cost generated by a complex fabrication process. Because of that, studies for forming a thin film in a patterning process using an imprinting mold have been in progress recently.

According to such a patterning process, imprinting resin is coated on a substrate. After that, an imprinting mold with grooves and projections contacts with the imprinting resin. When the grooves and projections of the imprinting mold are reversely transferred in the imprinting resin, the reverse-transferred imprinting resin is hardened in a hardening process. As a result, a desired thin pattern is formed on the substrate.

Here, the pressure applied when contacting the imprinting mold with the imprinting resin makes a gap narrow between the imprinting mold and the substrate. Because of that, the imprinting resin 6 is spread until an end of the substrate 4 in a capillary tube shape, as shown in FIG. 1, only to result in an error of being over-spread to a side of the substrate 4. In this case, a demolding seed between the imprinting mold 2 and the substrate 4 cannot be formed properly and there will be a problem that the demolding process between the imprinting mold 2 and the substrate cannot be performed properly.

### SUMMARY OF THE DISCLOSURE

Accordingly, the present invention is directed to an apparatus and a method of fabricating a thin film pattern.

An object of the present invention is to provide an apparatus and a method of fabricating a thin film pattern which can form a demolding seed between an imprinting mold and a substrate smoothly.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of fabricating a thin film pattern includes coating imprinting resin on the other region except an edge region of a substrate; forming a thin film pattern on the substrate by contacting an imprinting mold with the imprinting resin; and demolding the imprinting mold from the substrate.

In another aspect of the present invention, an apparatus of fabricating a thin film pattern includes a coating part configured to coat imprinting resin on the other region except an edge region of a substrate; and an imprinting system configured to form a thin film pattern on the substrate by contacting an imprinting mold with the imprinting resin, the imprinting system configured to demold the imprinting mold from the substrate.

According to the present invention, the imprinting resin is not coated on the edge region of the substrate or coated on the active region selectively by using the inkjet coater. That is, the imprinting resin is not coated on a non-active region except the active region of the substrate. Because of that, the non-coating region is used as demolding seed in the demolding process performed between the substrate and the imprinting mold. As a result, the imprinting mold may be demolded from the substrate stably according to the present invention and the demolding process time may be reduced accordingly. Moreover, according to the present invention, the non-coating region is used as demolding seed. As a result, the imprinting mold and the substrate may be demolded by a relatively smaller force than the force used to form the conventional demolding seed. Because of that, mold deformity generated by the force applied to the mold may be prevented and mold usage life may be enhanced. Also, according to the present invention, the resin form imprinting with no solvent may be coated to be a thin film pattern by using the inkjet coater. Because of that, it is possible to enlarge the substrate.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

In the drawings:

FIG. 1 is a sectional view illustrating an over-spreading of conventional imprinting resin;

FIG. 2 is a block view illustrating a thin film fabricating apparatus according to the present invention;

FIG. 3 is a sectional view illustrating a coating part shown in FIG. 2;

FIG. 4 is a perspective view illustrating a method for coating imprinting resin by using the coating part configured of an ink-jet coater;

FIGS. 5A and 5B are plane views illustrating imprinting resin according to the present invention, which is coated on the other region except an edge portion of a substrate;

FIG. 6 is a plane view illustrating imprinting resin which is selectively coated on an active region of the substrate;

FIGS. 7A to 7E are sectional views illustrating a method for fabricating a thin pattern according to the present invention;

FIG. 8 is a perspective view illustrating a liquid crystal display panel having the thin film pattern according to the present invention.

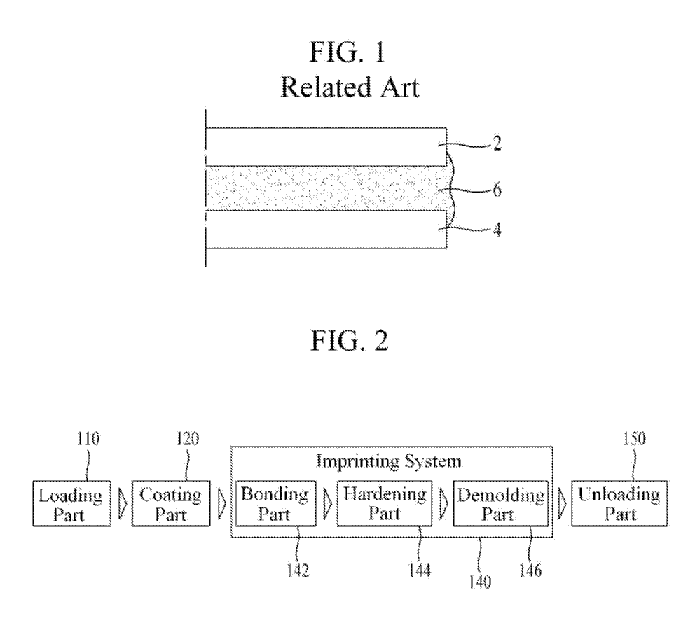

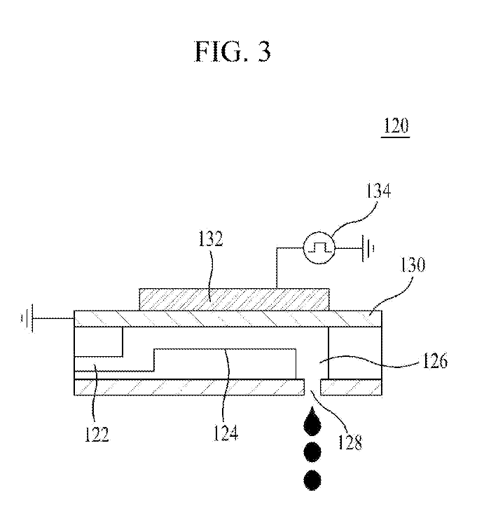

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

As follows, an exemplary embodiment of the present invention will be described in detail in reference to the accompanying drawings.

FIG. 2 is a diagram illustrating a thin film pattern fabricating apparatus according to the exemplary embodiment of the present invention.

The thin film fabricating apparatus shown in FIG. 2 includes a coating part 120, an imprinting system 140 having a bonding part 142, a hardening part 144 and a demolding part 146. The coating part 120, the bonding part 142, the hardening part 144 and the demolding part 146 are arranged in a line.

The coating part 120 coats imprinting resin on a substrate transferred by a loading part 110. Liquid polymer precursor is used as imprinting resin coated on the substrate by the coating part 120. The coating part 120 may be an inkjet coater capable of coating a predetermined material having no solvent such as liquid polymer precursor to be a thin film.

The coating part 120 configured of the inkjet coater includes a reserver 122, a restrictor 124, a pressure chamber 126, a nozzle 128 and a vibration plate 130 and a piezo element 132.

The reserver 122 reserves the liquid polymer precursor and it supplies the imprinting resin to the pressure chamber 126 via the restrictor 124.

The reserver 122 communicates with the pressure chamber 126 through the restrictor 124. The restrictor 124 functions as a passage of the liquid polymer precursor to the pressure chamber 126 from the reserver 122. When the vibration plate 130 is vibrated by the piezo element, the restrictor 124 may adjust the amount of the liquid polymer precursor supplied to the pressure chamber 126 from the reserver 122. In the meanwhile, the restrictor 124 is formed in an upper region of the inkjet coater 120, with a predetermined surface covered by the vibration plate 130, and the piezo element 132 is connected with a top surface of the vibration plate 130, corresponding to the position of the restrictor 124.

The pressure chamber 126 is connected with the restrictor 124 to communicate with the reserver 122. The pressure chamber 126 has a surface connected with the restrictor and it is connected with the nozzle 128 via the surface connected with the restrictor 124 and the other opposite surface thereof. This structure allows the pressure chamber 126 to receive the liquid polymer precursor from the reserver 122 via the restrictor 124 and the liquid polymer precursor to be re-supplied to the nozzle 128, such that the coating process may be performed. Here, the pressure chamber has a surface covered by the vibration plate 130 and the piezo element 132 is connected with the top surface of the vibrating plate 130 corresponding to the position of the pressure chamber 126, like the restrictor 124.

The piezo element 132 is connected with the top surface of the vibration plate 130, corresponding to the position of the restrictor 124, and it generates vibration according to a power supply 134. That is, the piezo element 132 generates vibration according to a voltage supplied thereto and it is employed to supply a predetermined pressure to the restrictor 124 via the vibration plate 130.

The nozzle 128 connected with the pressure chamber 126 is used to exhaust the imprinting resin. Once the vibration generated by the piezo element 132 is transferred to the pressure chamber 126 via the vibration plate 130, the pressure is applied to the pressure chamber 126 and this pressure allows the nozzle 128 to spray the liquid polymer precursor is exhausted toward the substrate, such that the coating process may be performed.

The vibration plate 130 is formed beyond the pressure chamber 126 and the restrictor 124. Such the vibration plate 130 may be connected to top regions of the pressure chamber 126 and the restrictor 124 as auxiliary structure and it may be formed in the other various methods.

The vibration plate 130 is transferring means used to transfer the vibration generated by the piezo element 132 to the pressure chamber 126. Because of that, the vibration plate 130 may be configured of a material or structure with enough elasticity, for example, metal and ceramic material.

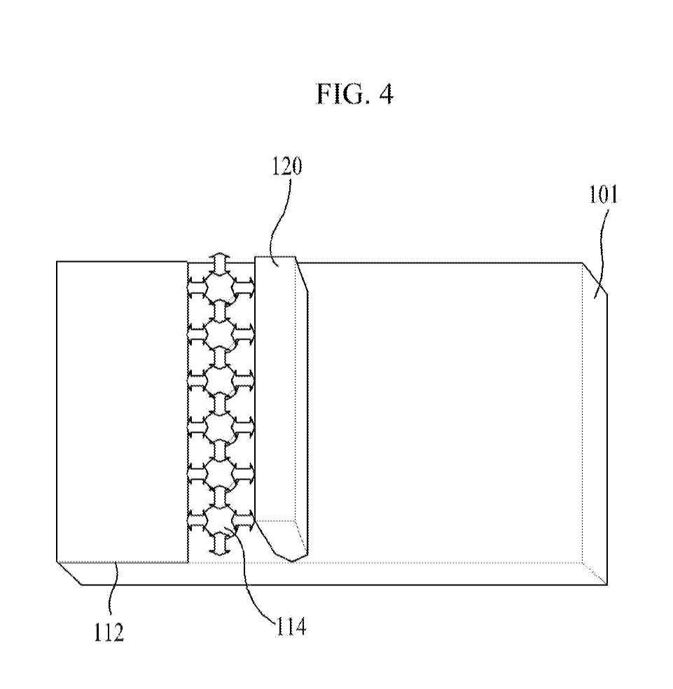

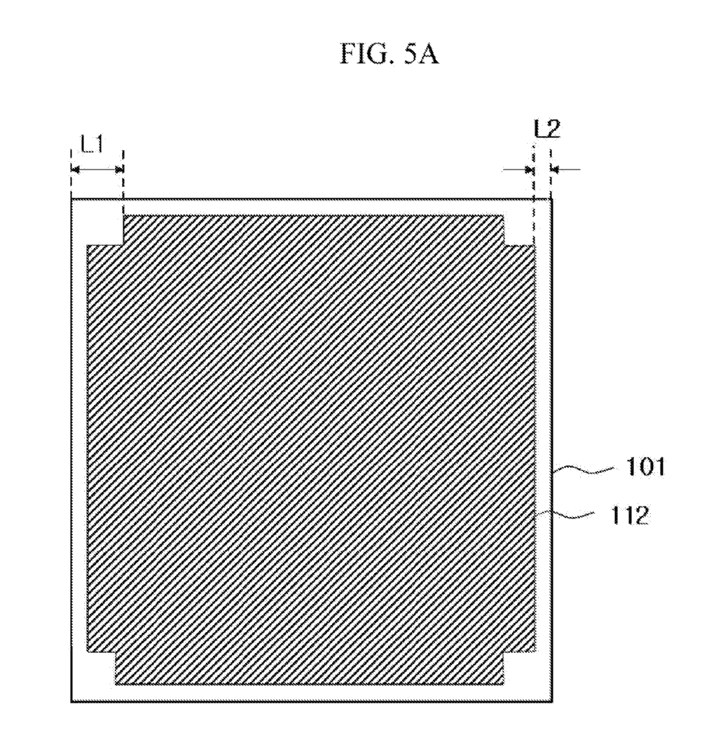

The coating part 120 configured of the inkjet coater described above adjusts the amount of the liquid polymer precursor which will be substantially coated on the substrate, using the piezo or electric field. Because of that, the liquid polymer precursor with no solvent may be coated as thin film. In other words, the coating part 120 configured of the inkjet coater exhausts at least one drop of the liquid polymer precursor 114 on the substrate 101 via each of the nozzles 128, as shown in FIG. 4. The exhausted liquid polymer precursor 114 is leveled in upward/downward and rightward/leftward directions, to be full-coated on the substrate 101. As a result, imprinting resin 112 is formed on the substrate 101.

In the meanwhile, the coating part 120 coats the imprinting resin not to be over-spread toward an outer end of the substrate 101, in consideration of spreadability of the imprinting resin formed by the pressure applied when bonding the imprinting mold with the substrate.

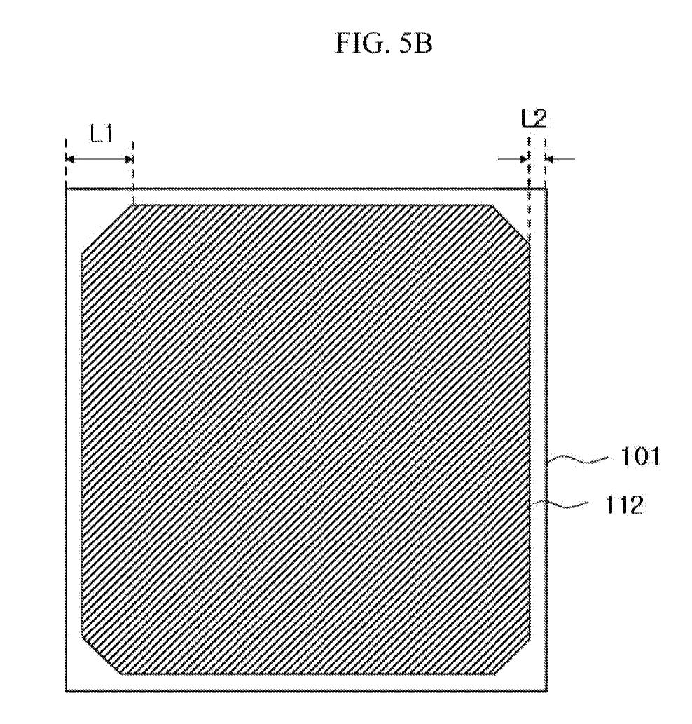

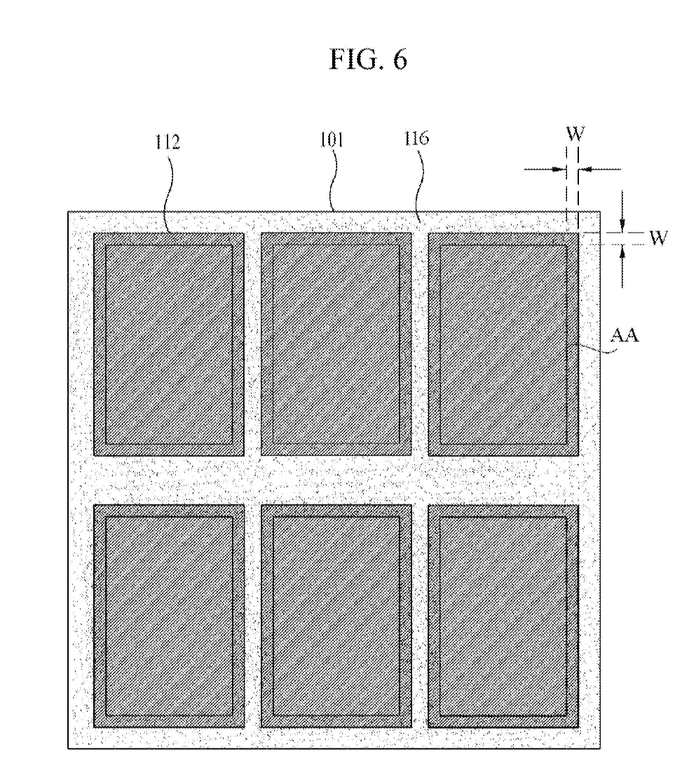

That is, the coating part 120 may not coat the imprinting resin 112 on an edge portion of the substrate 101 selectively as shown in FIGS. 5A and 5B, or it may coat it on an active region (AA) selectively as shown in FIG. 6.

Specifically, as shown in FIGS. 5A and 5B, the coating part 120 coats the imprinting resin 112 on the other region of the substrate 101 except polygonal such as a rectangle and triangle having the length (L1) of 10˜26 mm or hemispheric shaped non-coating zone of an edge portion of the substrate 101. Also, as shown in FIGS. 5A and 5B, the coating part 120 dose not coat the imprinting resin 112 in a length of about 1˜10 mm on a border region(e.g. edge bead region) of the substrate 101. To achieve this, an adhesive tape(not shown) is attached to the non-coating zone of the substrate 101, and then the imprinting resin 112 is coated on the substrate 101, and then the adhesive tape is removed.

As shown in FIG. 6, the coating part 120 coats the imprinting resin 112 in active regions (AA) formed on a single parent substrate selectively. At this time, the imprinting resin 112 is overlapped with a light shielding layer (116, for example, an outer black matrix of the liquid crystal display device) covering each active region (AA), with a width of 5˜20 mm, and an edge of the light shielding layer 116 is spaced apart a predetermined distance from the edge portion of the substrate 101, with a critical dimension of 1˜26 mm. As a result, thickness reduction of the imprinting resin 112 located in an outer area of the active region generated by the spreading of the imprinting resin 112 when bonding the imprinting mold with the substrate may be prevented.

The imprinting system 140 includes the bonding part 142, the hardening part 144 and the demolding part 146 arranged in a line, as shown in FIG. 2. The bonding part 142, the hardening part 144 and the demolding part 146 are arranged in a line on a single device or they are located in different devices arranged in a line, respectively.

The imprinting mold having the grooves and the projections is aligned on the bonding part 142. The imprinting mold presses the substrate 101 to contact with the imprinting resin. After that, the imprinting resin is moved into the grooves of the imprinting mold.

A heat generating part or light generating part is located in the hardening part 144 to harden the imprinting resin in contact with the imprinting mold. That is, the imprinting resin moved into the grooves of the imprinting mold is hardened by the heat or the light and a thin film pattern is then formed on the substrate 101. Here, the thin film pattern has a reverse-transferred pattern with respect to the grooves and projections of the imprinting mold.

A suction pad is located in the demolding part 146 to demold the imprinting mold bonded with the substrate. In other words, the suction pad bonded with the imprinting mold is lifted in an opposite direction to the substrate 101 and the imprinting mold is demolded from the substrate 101 having the thin film pattern formed thereon. At this time, air such as N₂ is sprayed in the non-coating zone of the edge portion of the substrate having the thin film pattern formed thereon. If then, the air such as N₂ is injected between the imprinting mold and the substrate 101 smoothly and it is easy to demold the imprinting mold from the substrate 101.

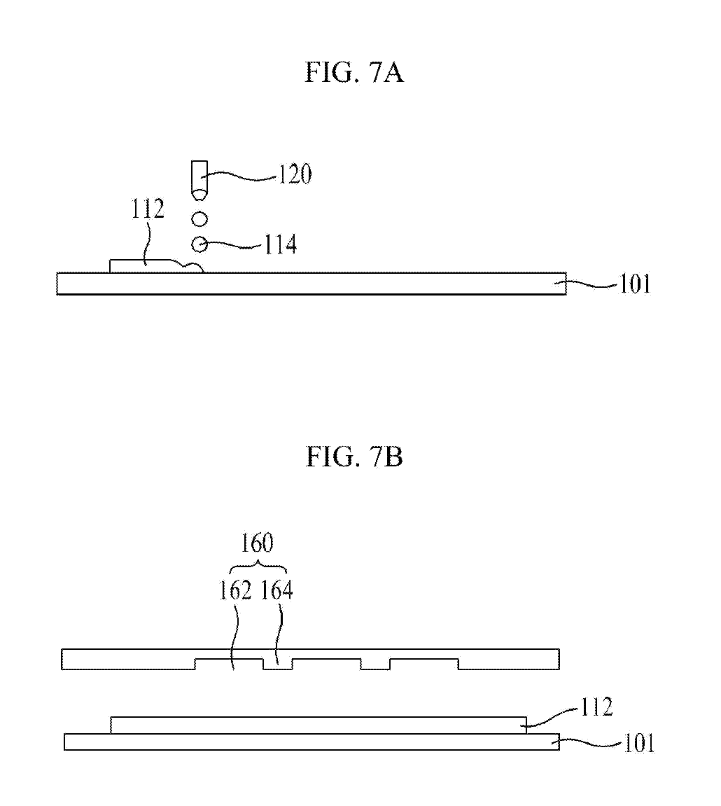

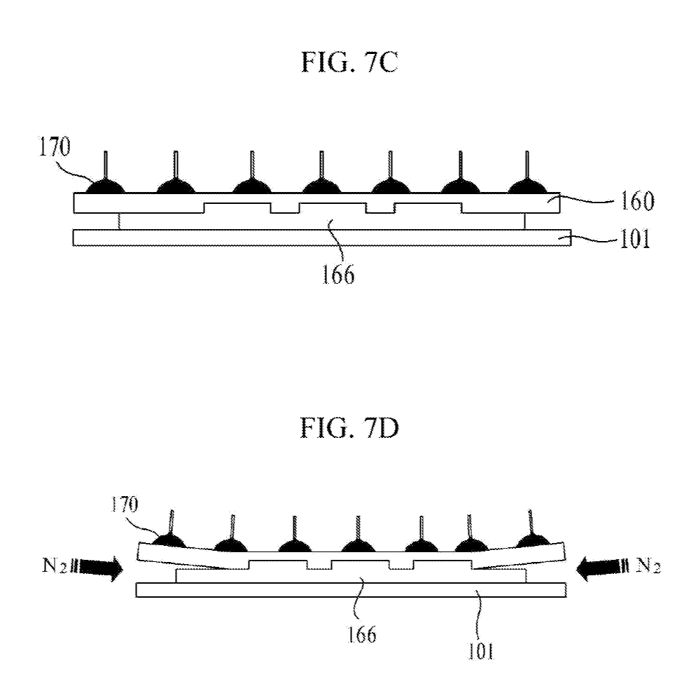

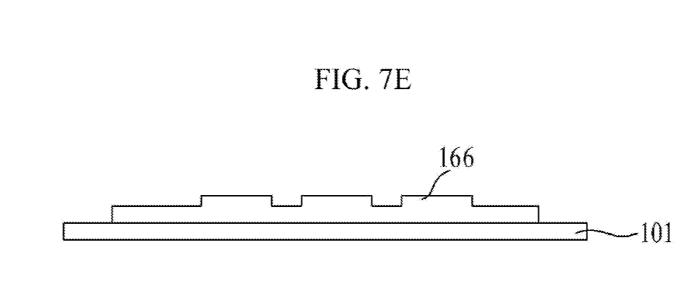

FIGS. 7A to 7E are sectional views illustrating a method of fabricating the thin film pattern according to the present invention.

As shown in FIG. 7A, the liquid polymer precursor 114 is sprayed on a desired region of the substrate 101 by the coating part 120 configured of an inkjet coater selectively such that the imprinting resin 112 may be coated. At this time, the imprinting resin 112 may be formed on the other region except the edge portion of the substrate 101 or the active region selectively.

The imprinting mold 160 is aligned on the substrate 101 having the imprinting resin 112 formed thereon, as shown in FIG. 7B. The imprinting mold 160 has grooves 162 and projections 164. Here, the imprinting mold 160 is formed of Polydimethysiloxane (PDMS), for example.

Hence, the imprinting mold 160 is bonded with the imprinting resin 112. After that, the imprinting resin 112 is moved into the grooves 162 of the imprinting mold 160 and a thin film pattern 166 is formed on the substrate 101 as shown in FIG. 7C. The thin film pattern 166 has a reverse-transferred pattern with respect to the grooves 162 of the imprinting mold 160. The thin film pattern 166 formed on the substrate 101 is hardened by heat or lights, in a state of being bonded with the imprinting mold 160.

After that, a top surface of the imprinting mold 160 bonded with the substrate 101 having the thin film pattern 166 formed thereon contacts with the suction pad 170.

Hence, as shown in FIG. 7D, air such as N2 is injected between the non-coated region of the imprinting resin 112 and the imprinting mold 160, simultaneously with the imprinting mold 160 being lifted in an opposite direction of the substrate 101 by using the suction pad 170. Because of that, the imprinting mold 160 is demolded from the substrate 101 having the thin film pattern 166 formed thereon as shown in FIG. 7E.

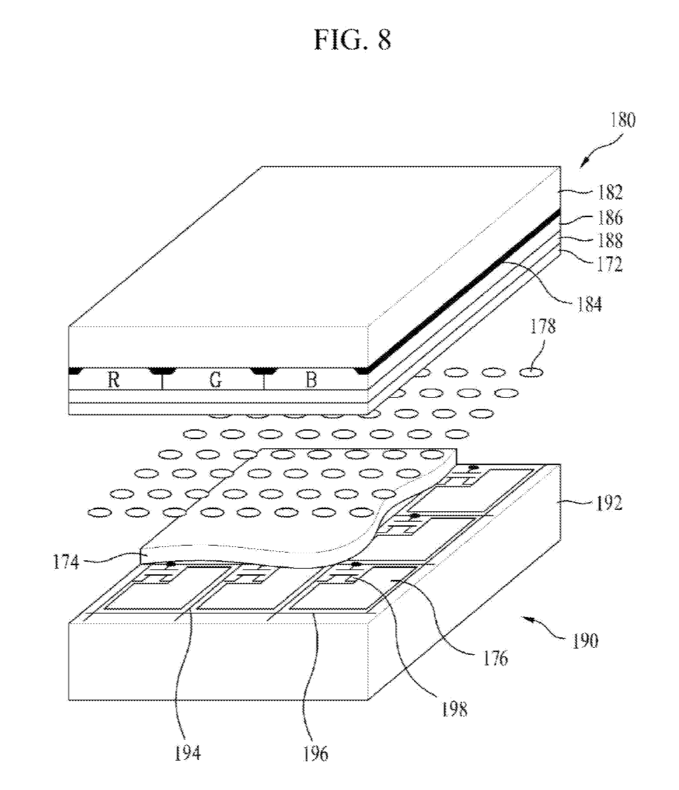

In the meanwhile, the thin film pattern 166 formed by the imprinting mold 110 according to the present invention may be applicable to a liquid crystal display panel shown in FIG. 8. Specifically, the liquid crystal display panel according to the present invention shown in FIG. 8 includes a thin film transistor substrate 190 and a color filter substrate 180, which are bonded oppositely with a liquid crystal layer 178 formed there between.

The color filter substrate 180 includes a black matrix 184, a color filter 186, a common electrode 188, a column spacer (not shown) and a top alignment layer 172 for liquid alignment, which are formed on the top substrate 182 sequentially.

The thin film transistor substrate 190 includes gate lines 196 and data lines 194 formed on a bottom substrate 192 alternatively, thin film transistors 198 adjacent to intersections of the gate and data lines 196 and 194, pixel electrodes 176 formed in pixel regions formed by the intersection structure, and a bottom alignment layer 174 for aligning liquid crystal.

A photoresist pattern used as mask to pattern the thin film pattern formed of organic material, including the color filter 186, the black matrix 184, the column spacer and the top/bottom alignment layers 172 and 174 of the liquid crystal display panel and the thin film pattern formed of non-organic material, including the thin film transistors 198, the gate lines 196, the data lines 194 and the pixel electrodes 176 may be formed according to the fabricating process according to the present invention.

Rather than that, the thin film pattern fabricating apparatus according to the present invention forms a thin film or a back film of a flat display device including a plasma display panel, a field luminescence display panel and a field emission display.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of fabricating a thin film pattern comprising:
coating imprinting resin on the other region except an edge region of a substrate;
forming a thin film pattern on the substrate by contacting an imprinting mold with the imprinting resin; and
demolding the imprinting molding from the substrate.

2. The method of fabricating the thin film pattern of claim 1, wherein the coating of the imprinting resin comprises,
aligning an inkjet coater on the substrate; and
coating the imprinting resin on the other region except the edge region of the substrate by using the inkjet coater.

3. The method of fabricating the thin film pattern of claim 1, wherein the imprinting resin is coated on the other region except a polygonal or hemispheric-shaped edge region of the substrate with a critical dimension of 10˜26 mm.

4. The method of fabricating the thin film pattern of claim 1, wherein the imprinting resin is overlapped with a light shielding layer formed in an outer region of the substrate, with a predetermined width of 5 mm or more.

5. An apparatus of fabricating a thin film pattern comprising:
a coating part configured to coat imprinting resin on the other region except an edge region of a substrate; and
an imprinting system configured to form a thin film pattern on the substrate by contacting an imprinting mold with the imprinting resin and to demold the imprinting mold from the substrate.

6. The apparatus of fabricating the thin film pattern of claim 5, wherein the coating part coats the imprinting resin on the other region of the substrate except a polygonal or hemispheric-shaped edge region with a critical dimension of 10˜26 mm.

7. The apparatus of fabricating the thin film pattern of claim 5, wherein the coating part forms the imprinting resin overlapped with a light shielding layer formed in an outer region of the substrate, with a width of 5 mm or more.

8. The apparatus of fabricating the thin film pattern of claim 5, wherein the imprinting resin is formed of liquid polymer precursor with no-solvent and the coating part is an inkjet coater.
